(19) United States
(12) Patent Application Publication
(10) Pub. No.: US 2020/0205589 A1
(43) Pub. Date: Jul. 2, 2020

(54) CUSTOM FORMABLE-COLLAPSIBLE DEVICE FOR SUPPORTING AT LEAST A PORTION OF A HUMAN BODY

(71) Applicant: KONINKLIJKE PHILIPS N.V., Eindhoven (NL)

(72) Inventor: PETER CHI FAI HO, PITTSBURGH, PA (US)

(21) Appl. No.: 16/719,037

(22) Filed: Dec. 18, 2019

Related U.S. Application Data
(60) Provisional application No. 62/787,542, filed on Jan. 2, 2019.

(51) Int. Cl. A47G 9/10

(52) U.S. Cl. CPC A47G 9/10; B33Y 80/00; A47G 2009/1018

(57) ABSTRACT

A device for supporting at least a portion of a human body. The device includes: a deformable, yet resilient, three-dimensional lattice structure having a plurality of interconnected arm elements; and a continuous airspace disposed among the lattice structure.

### CROSS-REFERENCE TO RELATED APPLICATIONS

This patent application claims the priority benefit under 35 U.S.C. § 119(e) of U.S. Provisional Application No. 62/787,542, filed on Jan. 2, 2019, the contents of which are herein incorporated by reference.

### BACKGROUND OF THE INVENTION

### 1. Field of the Invention

The present invention relates to devices for supporting at least a portion of a human body, and more particularly to pillows for supporting a human head. The present invention further relates to methods for forming such devices.

### 2. Description of the Related Art

Ergonomically shaped pillows, also commonly referred to as contour pillows, are commonly known. Such pillows come in various shapes and sizes and are typically formed from foam, and typically from a memory foam. While good for providing support for a user's head, such foam materials can undesirably retain heat which can cause discomfort for a user. Additionally, such pillows are generally bulky (i.e., relatively heavy, generally voluminous) in order to provide the needed support for a user's head.

### SUMMARY OF THE INVENTION

Embodiments of the present invention address shortcomings in the art by providing, as one aspect, a device for supporting at least a portion of a human body. The device comprises: a deformable, yet resilient, three-dimensional lattice structure having a plurality of interconnected arm elements; and a continuous airspace disposed among the lattice structure.

Each of the arm elements may have a diameter of at least 0.5 mm. The lattice structure may be formed via an additive manufacturing process. The device may be a pillow for use in supporting a human head. The lattice structure may comprise a plurality of portions, and wherein at least one of the: geometry, dimensions, density, or material composition of one of the portions varies from another one of the portions. The device may further comprise: a deformable, yet resilient, three-dimensional second lattice structure having a plurality of interconnected second arm elements; and a second continuous airspace disposed among the second lattice structure. The continuous airspace and the second continuous airspace may be separated. The continuous airspace and the second continuous airspace may be portions of a single continuous airspace. The lattice structure may be readily collapsible from: an unstressed position wherein the lattice structure and the airspace occupy a first volume, to a stressed position wherein the lattice structure and the airspace occupy a second volume which is less than 20% of the first volume. The lattice structure may have a first stiffness in a first direction and a second stiffness in a second direction; and the second stiffness may be less than the first stiffness. The second direction may be generally perpendicular to the first direction.

As another aspect of the invention, a method of forming a pillow for supporting a human head, the method comprising: using an additive manufacturing process, forming a deformable, yet resilient, three-dimensional lattice structure having a plurality of inter-linked arm elements and a continuous airspace disposed among the lattice structure.

The formed lattice structure may have a density defined by the volume of the lattice structure in a given volume of the pillow, and forming the lattice structure may comprise: forming a first portion having a first density, and forming a second portion having a second density different than the first density. Forming the lattice structure may comprise forming a third portion having a third density different than each of the first density and the second density. Forming the lattice structure may comprise forming a fourth portion having a fourth density different than each of the first density, the second density, and the third density. The first portion may be formed at a predetermined first position in the pillow in accordance with anatomical data related to the patient, and the second portion may be formed at a predetermined second position in accordance with the anatomical data. The anatomical data may be obtained via at least one of: a body scan of the patient, direct measurement of the patient, and/or personal preferences of the patient.

As yet another aspect of the invention, a system for forming a pillow for supporting a human head comprises: a 3D printing device; and a processing device structured to cause the 3D printing device to form a deformable, yet resilient, three-dimensional lattice structure having a plurality of inter-linked arm elements and a continuous airspace disposed among the lattice structure.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1 is a simplified isometric view of a representative portion of a lattice structure in accordance with one example embodiment of the present invention;

FIG. 2 is a simplified elevation view of a side of the portion of the lattice structure of FIG. 1 as generally indicated in FIG. 1;

FIG. 3 is a simplified elevation view of another side of the portion of the lattice structure of FIG. 1, adjacent the side shown in FIG. 2, as generally indicated in FIG. 1;

FIG. 4 shows a comparison of the elevation view of the lattice structure of FIG. 1 in a relaxed, uncompressed state (such as shown in FIG. 2), and in a compressed state resulting from application of an applied force;

FIG. 5 is a simplified elevation view of a side of a portion of a lattice structure similar to that of FIG. 2 in accordance with another example embodiment of the present invention;

FIG. 6A is a simplified elevation view of a pillow utilizing a lattice structure in accordance with one example embodiment of the present invention shown supporting a human head;

FIG. 6B is a simplified isometric view of the pillow of FIG. 6A shown in a uncompressed, state;

FIG. 6C is a simplified isometric view of the pillow of FIGS. 6A and 6B shown in a compressed state;

FIG. 7 is a simplified isometric view of a pillow including two different lattice structures in accordance with one example embodiment of the present invention;

FIG. 8 is a simplified isometric view of a pillow including three different lattice structures in accordance with one example embodiment of the present invention; and

FIG. 9 is a simplified isometric view of a pillow including four different lattice structures in accordance with one example embodiment of the present invention.

### DETAILED DESCRIPTION OF EXEMPLARY EMBODIMENTS

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are coupled directly in contact with each other (i.e., touching). As used herein, “fixedly coupled” or “fixed” means that two components are coupled so as to move as one while maintaining a constant orientation relative to each other.

As employed herein, the statement that two or more parts or components “engage” one another shall mean that the parts exert a force against one another either directly or through one or more intermediate parts or components. As employed herein, the term “number” shall mean one or an integer greater than one (i.e., a plurality). Directional phrases used herein, such as, for example and without limitation, left, right, upper, lower, front, back, on top of, and derivatives thereof, relate to the orientation of the elements shown in the drawings and are not limiting upon the claims unless expressly recited therein.

Embodiments of the present invention utilize three-dimensional lattice structures formed via additive manufacturing to form members, or selected portions of members used in supporting human bodies, or selected portions thereof. Examples of such structures include pillows for supporting human heads. The use of such lattice structures provides for arrangements having structural properties which may be readily varied in order to accommodate particular needs/wants of a particular user. Such lattice structures also provide for structures which are largely hollow and thus naturally provide air permeability which is good for regulating the body temperature of a user. Such largely hollow arrangements also may readily be arranged so as to collapse in a desired manner and thus occupy a minimal volume for storage and/or travel purposes.

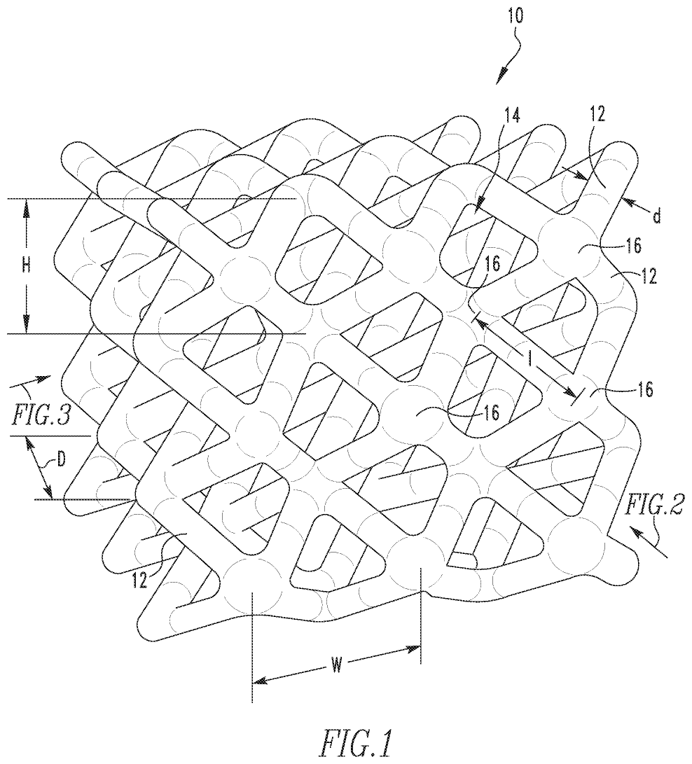

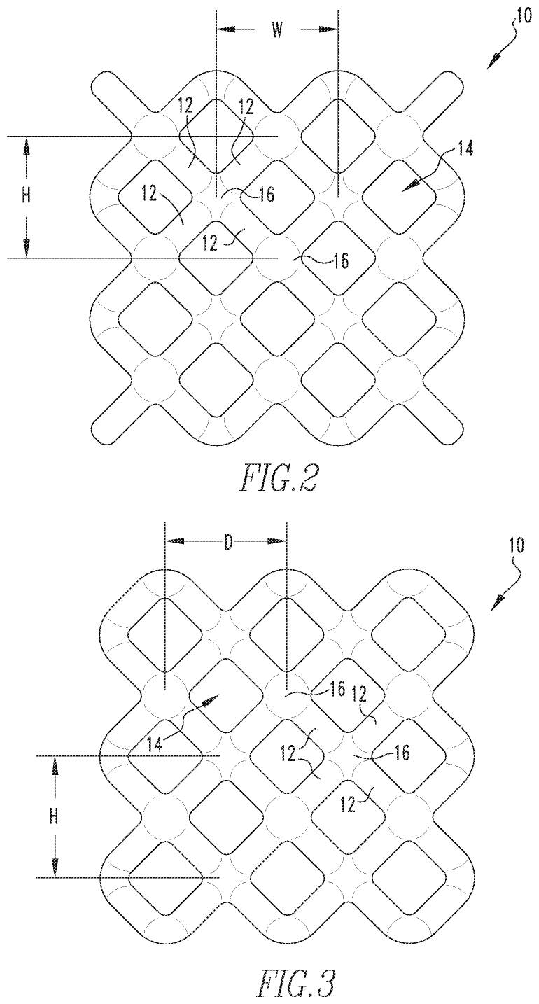

Referring to FIGS. 1-3, a representative portion of a three-dimensional lattice structure 10 in accordance with one example embodiment of the present invention is shown. Lattice structure 10 includes a plurality of interconnected arm elements 12 (only a selected few example elements 12 have been labeled) and a continuous airspace 14 disposed among the plurality of arm elements 12. More particularly, arm elements 12 are interconnected by a plurality of connection points 16 (only a selected few example elements 16 have been labeled), such that each arm element 12 generally extends a length l between a pair of connection points 16, with each connection point 16 serving as a connection between at least two arm elements 12, and, in the illustrated example, between eight arm elements 12 (except for those near the boundary of lattice 10). In the example embodiment, each connection point 16 is spaced a height H from adjacent connection points 16 aligned above or below, and a width W or a depth D between adjacent connection points 16 at the same elevation. Other adjacent connection points 16, i.e., those not at the same elevation or directly above or below are each spaced the absolute distance 1 (i.e., the length of an arm element 12) from a given connection point 16.

Lattice structure 10 is formed via an additive manufacturing process (e.g., without limitation, 3D printing) from one or more elastic materials (e.g., 3D printable polymers in various forms such as powder, liquid or filament, etc. with elasticity ranges from a wide spectrum that couples with the size and density of the lattice structure to provide the desirable resilience or springiness. Accordingly, the dimensions (e.g., diameter d, length 1) of each arm member 12 is constrained only by the limitations of the additive manufacturing process and materials utilized to form lattice structure 10. In example embodiments of the present invention, arm members 12 having diameters d generally in the range of 0.5 to 5 mm and length 1 from 2 to 25 mm have been employed. It is to be appreciated, however, that other dimensions may be utilized without varying from the scope of the present invention. Similarly, the potential geometries of lattice structure 10 are only constrained by the limitations of the additive manufacturing process utilized to form lattice 10. Accordingly, it is to be appreciated that one or more of the general shape, spacing, geometry, or spacing of lattice structure 10 may be varied without varying from the scope of the present invention.

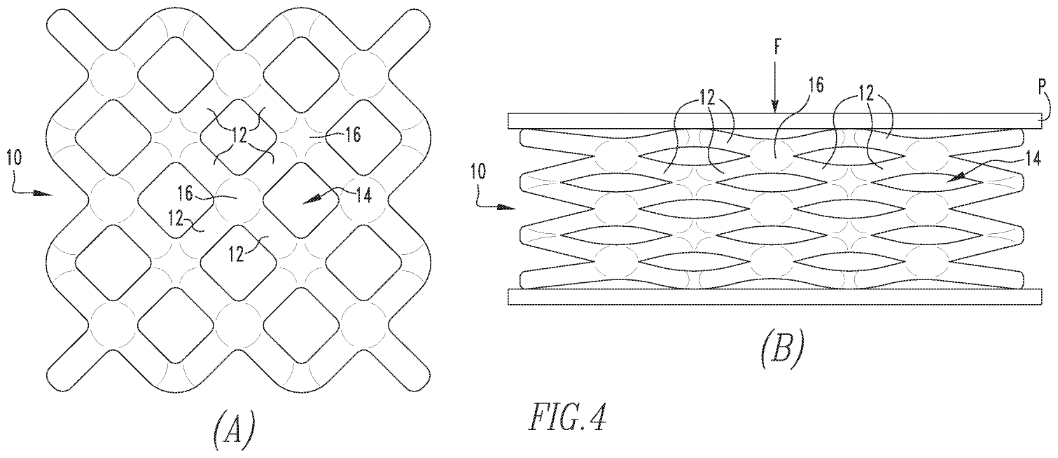

The arrangement, composition and density (i.e., the volume of lattice 10 in a given volume of space) of lattice structure 10 provides for an arrangement which is readily compressible, more than an equivalent foam material due to the large relative volume of airspace 14 to volume of lattice structure 10. FIG. 4 shows a comparison of lattice structure 10 in a relaxed, uncompressed state (A), and in a (partially) compressed state (B) resulting from a force F applied via a plate P to the top of lattice structure 10. By varying one or more of: the geometry, material(s), and/or density of lattice structure 10, the compressibility, or lack thereof (i.e., stiffness), of lattice structure 10 in one or more directions may be selectively tailored to meet requirements for a particular application. For example, FIG. 5 shows an elevation view of a lattice structure 110, which is generally similar to lattice structure 10 previously discussed except that the height H between vertically aligned connection points 16 has been increased to roughly 1.5×width W, as compared to lattice structure 10 in which height H is generally equal to width W. Due to such variation, lattice structure 110 is less compressible, i.e., more stiff, in a first direction D1, and more compressible, i.e., less stiff, in a second direction D2, which is generally perpendicular to first direction D1.

As an alternative to repeated particular geometries such as illustrated in the previous example embodiments, lattice structures having generally random, or “organic” shapes may be employed without varying from the scope of the present invention. In such organic structures, the compressibility, or lack thereof (i.e., stiffness) may be selectively tailored to meet requirements for a particular application by varying one or both of the density of the organic lattice structure and/or the material(s) from which such organic lattice structure is formed.

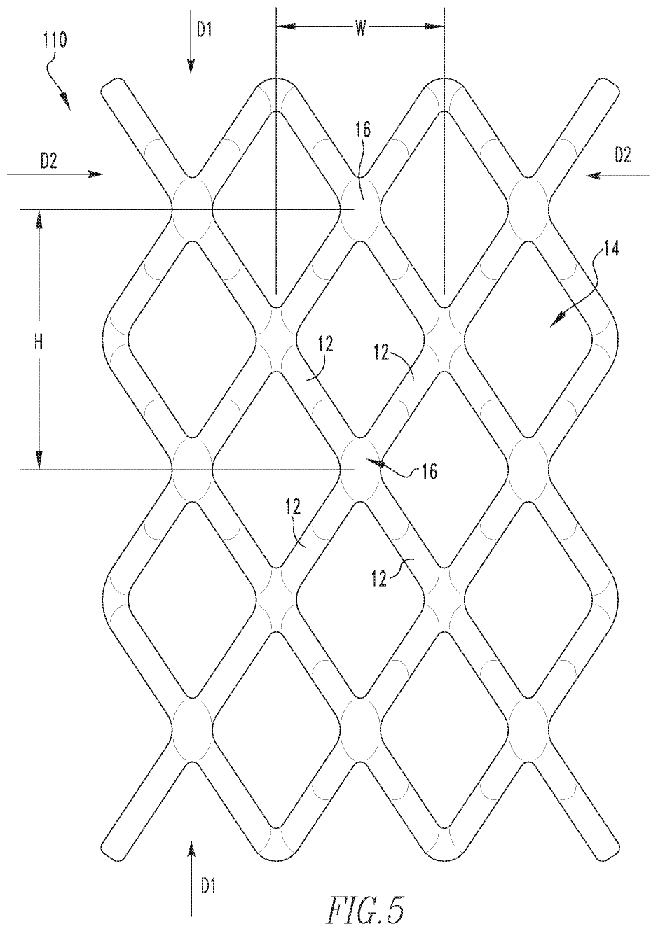

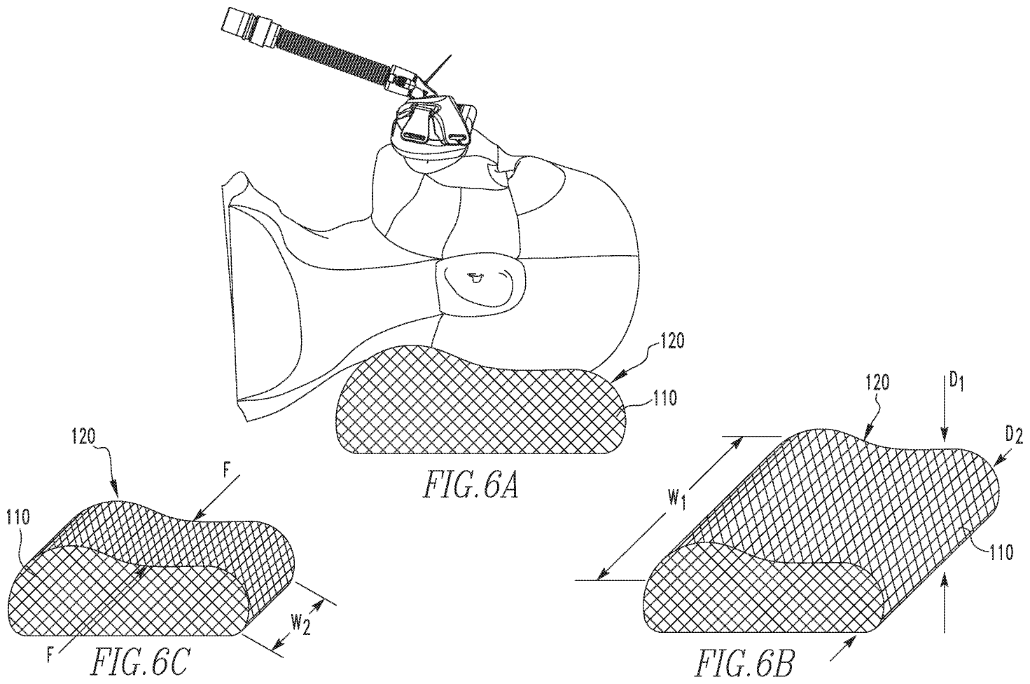

Having thus described basic examples of lattice structures in accordance with examples of the present invention, support structures for supporting all or portions of a human body which employ such lattice structures will now be described. Referring now to FIG. 6A, an example pillow 120, for use in supporting a human head, such as when receiving a CPAP treatment (as shown) or generally during sleep, in accordance with one example embodiment of the present invention which utilizes a single lattice structure 110 (shown schematically) such as shown in FIG. 5 is shown. Lattice structure 110 is arranged so as to provide a sufficient stiffness in direction D1 so as provide adequate support to a patient's head. Lattice structure 110 is further arranged so as to be less stiff in direction D2, so as to be more readily collapsible, and thus occupy minimal space, for travel or storage purposes. FIG. 6C shows pillow 120 in a travel position in which lattice 110 has been collapsed by forces applied (e.g., via a patient's hands/arms, a drawstring, etc.) generally in direction D2 of FIG. 6B. As a result of the design of lattice structure 110, such collapsing of pillow 120 results in a reduction of the width of pillow 120 from an initial width W1 (FIG. 6B) to a second width W2 (FIG. 6C) generally in the range of 20 to 50% of initial width W1.

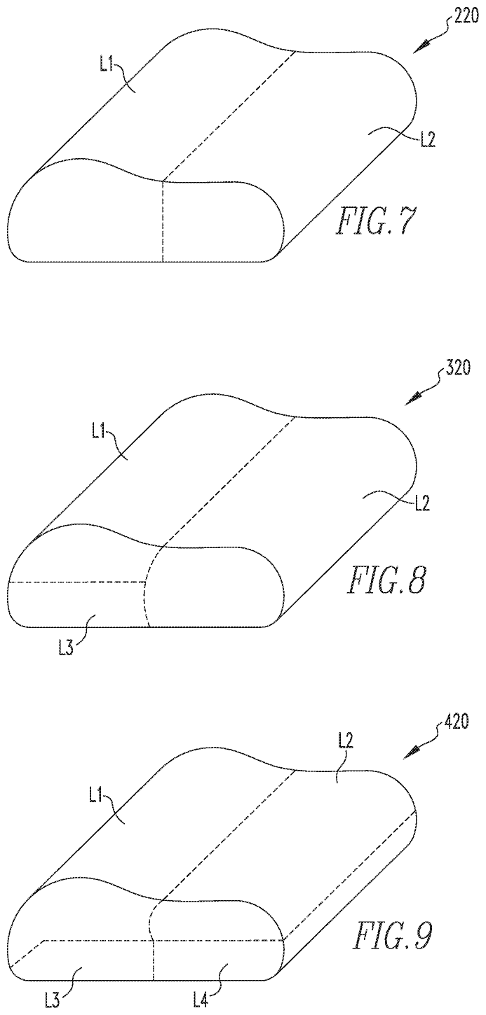

FIGS. 7-9 show simplified isometric views of pillows 220, 320, and 420 which are similar to pillow 120 but which utilize different lattice structures in different areas of the pillow to provide for a more tailored or customizable arrangement in which different stiffness's may be provided in different areas of the pillow. More particularly, pillow 220 of FIG. 7 uses a first lattice structure, shown generally at L1 positioned generally to support the neck of a user and a second lattice structure L2 positioned to support the head of a user. Pillow 320 of FIG. 8 is similar to pillow 220 but further includes a third lattice structure L3 as an underlying base to first lattice structure L1. Pillow 420 of FIG. 9 is similar to pillow 320 but further includes a fourth lattice structure L4 as an underlying base to second lattice structure L2.

From the example pillows 120, 220, 320 and 420, it is thus to be appreciated that numerous different lattice structures may be employed in various different areas of a given pillow without varying from the scope of the present invention. Such different lattice structures may be formed so as to have a continuous airspace throughout all of the different lattice portions or to have one or more of the different lattice portions isolated, e.g., via a flexible membrane, a volume of another material (e.g., foam) or other suitable arrangement. It is also to be appreciated that lattice structures such as described herein may be utilized with other materials, e.g., foam, or other suitable material(s), to form pillows without varying from the scope of the present invention. It is also to be appreciated that although the example pillows illustrated herein generally show distinctive boundaries between lattice structures or lattice zones, such boundaries may be smoothed/blended so as to be generally imperceptible due to the nature of the additive manufacturing process (i.e., adjacent lattice structures may generally morph from one lattice structure to the next).

From the foregoing examples it is thus to be appreciated that example embodiments of the present invention provide for support structures which may be readily produced via an additive manufacturing process such as a 3D printer having a processing device programmable to instruct the printer to create arrangements such as described herein. Such process allows for a customized solution to be readily produced.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A device for supporting at least a portion of a human body, the device comprising:
a deformable, yet resilient, three-dimensional lattice structure having a plurality of interconnected arm elements; and
a continuous airspace disposed among the lattice structure.

2. The device of claim 1, wherein each of the arm elements have a diameter (d) of at least 0.5 mm.

3. The device of claim 1, wherein the lattice structure is formed via an additive manufacturing process.

4. The device of claim 1, wherein the device is a pillow for use in supporting a human head.

5. The device of claim 1, wherein the lattice structure comprises a plurality of portions, and wherein at least one of the: geometry, dimensions, density, or material composition of one of the portions varies from another one of the portions.

6. The device of claim 1, further comprising:
a deformable, yet resilient, three-dimensional second lattice structure having a plurality of interconnected second arm elements; and
a second continuous airspace disposed among the second lattice structure.

7. The device of claim 6, wherein the continuous airspace and the second continuous airspace are separated.

8. The device of claim 6, wherein the continuous airspace and the second continuous airspace are portions of a single continuous airspace.

9. The device of claim 1, wherein the lattice structure is readily collapsible from: an unstressed position wherein the lattice structure and the airspace occupy a first volume, to a stressed position wherein the lattice structure and the airspace occupy a second volume which is less than 20% of the first volume.

10. The device of claim 1, wherein the lattice structure has a first stiffness in a first direction and a second stiffness in a second direction; and wherein the second stiffness is less than the first stiffness.

11. The device of claim 10, wherein the second direction is generally perpendicular to the first direction.

12. A method of forming a pillow for supporting a human head, the method comprising:
using an additive manufacturing process, forming a deformable, yet resilient, three-dimensional lattice structure having a plurality of inter-linked arm elements and a continuous airspace disposed among the lattice structure.

13. The method of claim 12, wherein the formed lattice structure has a density defined by the volume of the lattice structure in a given volume of the pillow, and
wherein forming the lattice structure comprises:
forming a first portion having a first density, and
forming a second portion having a second density different than the first density.

14. The method of claim 13, wherein forming the lattice structure comprises forming a third portion having a third density different than each of the first density and the second density.

15. The method of claim 14, wherein forming the lattice structure comprises forming a fourth portion having a fourth density different than each of the first density, the second density, and the third density.

16. The method of claim 13, wherein the first portion is formed at a predetermined first position in the pillow in accordance with anatomical data related to the patient, and wherein the second portion is formed at a predetermined second position in accordance with the anatomical data.

17. The method of claim 16, wherein the anatomical data was obtained via at least one of: a body scan of the patient, direct measurement of the patient, and/or personal preferences of the patient.

18. A system for forming a pillow for supporting a human head, the system comprising:
a 3D printing device; and
a processing device structured to cause the 3D printing device to form a deformable, yet resilient, three-dimensional lattice structure having a plurality of inter-linked arm elements and a continuous airspace disposed among the lattice structure.
